(19) United States
(12) Patent Application Publication
(10) Pub. No.: US 2007/0113713 A1
(43) Pub. Date: May 24, 2007

(54) Method of aligning a cutting tool

(76) Inventors: Steven Robert Hayashi, Niskayuna, NY (US); Mark Marshall Meyers, Mechanicville, NY (US); Paul Richard Myers, Clifton Park, NY (US)

Correspondence Address: CANTOR COLBURN, LLP, 55 GRIFFIN ROAD SOUTH, BLOOMFIELD, CT, 06002, US

(21) Appl. No.: 11/286,034

(22) Filed: Nov. 23, 2005

(51) Int. Cl. B26D 1/00; B26D 3/00

(52) U.S. Cl. 83/13

(57) ABSTRACT

Disclosed herein is a method for aligning a cutting tool comprising displacing a first slide comprising a microscope in a first direction at a first speed; displacing a second slide comprising an adjustable tool holder and a cutting tool in a second direction at a second speed; wherein the adjustable tool holder is in operative communication with the cutting tool; observing an actual path of travel of a cross hair center of the microscope with respect to a cutting edge of the cutting tool; and adjusting the position of the cutting tool so that the cutting edge of the cutting tool and the cross hair center lie in the same plane during the travel of the cross hair center.

### BACKGROUND

This disclosure relates to a method of aligning a cutting tool disposed upon a turning machine. In particular, it relates to a method of alignment for a diamond-cutting tool in order to manufacture a brightness enhancing display film with prism apexes aligned normal to the surface and thus having maximum on-axis brightness in a liquid crystalline backlight assembly.

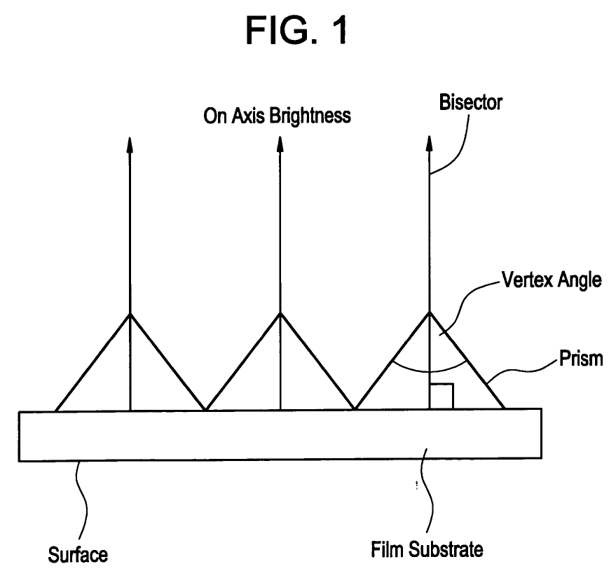

Brightness enhancing display films generally termed “prism sheets” are used in liquid crystalline display devices in order to collimate the light passing through a liquid crystal display. It is generally desirable to employ prisms on the brightness enhancing display films that have vertex angles of about 90 degrees. It is further desirable for a bisector of the vertex of the prisms to be normal to the surface of the brightness enhancing display film. This is shown in the FIG. 1, which is detailed below.

If the bisector of the vertex is not normal to the base, there is a reduction in the on-axis concentration of light and a displacement of the direction of maximum light concentration. A “misalignment angle” can be used to characterize the difference between the bisector of the vertex angle of the prism and the surface of the brightness enhancing display film. The misalignment angle is defined as 90 degrees minus the angle between bisector of the vertex and the surface of the brightness enhancing display film, i.e. the optimum display film performance is obtained as the misalignment angle is reduced to zero.

The on-axis brightness is the brightness measured in a direction perpendicular to the surface of the brightness enhancing display film. The surface of the brightness enhancing display film is parallel to the base of the prisms that are disposed upon the film substrate as shown in the FIG. 1. FIG. 1 is an exemplary depiction of a prism disposed upon a film substrate. The prism together with the film substrate comprises the brightness enhancing display film.

Brightness enhancing display films are manufactured by pressing a malleable material against a prism-shaped mold. The malleable material is disposed upon an optically transparent film substrate. Possible manufacturing processes include melt calendaring, embossing, injection molding, compression molding, casting and curing of thermally cured resin onto a substrate, and casting and curing of UV cured resin onto the film substrate. For example, the mold can be an electroform which is a replica of a drum that has a negative image of a prism surface machined on its outer surface by using a turning machine such as a lathe. The prisms on the drum are machined with a diamond-cutting tool.

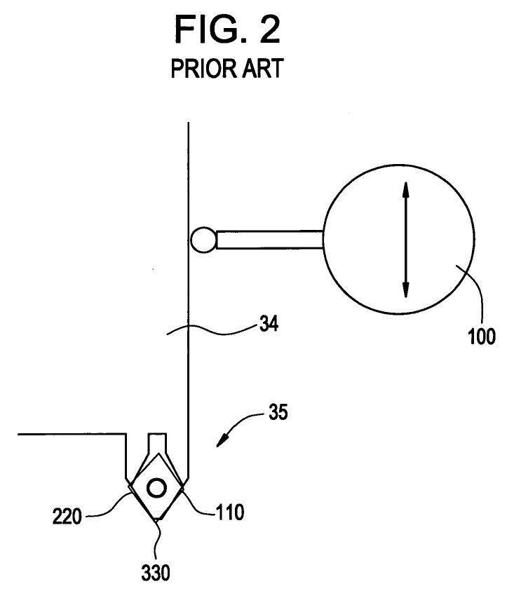

In general, a misalignment of the cutting tool during the machining can result in a defective drum. The defective drum produces a defective electroform which then stamps out a defective brightness enhancing display film. One method of correcting this defect is to try to align the cutting tool by realigning the cutting tool holder using the edge of the tool holder as a locating device. An embodiment of this method is depicted in the FIG. 2. In this method, a position indicator 100 is displaced along the edge of a tool holder 34 to determine its position. The tool holder 34 is either matingly engaged or fixedly attached to a cutting tool 35 that comprises a first cutting edge 110, a second cutting edge 220 and a cutting tip 330. If the tool holder 34 is determined to be askew, it is tapped back into alignment. This method however, does not take into account the alignment of the cutting tool 35 in the tool holder 34 or the alignment of the tool holder within tool base (not shown) and consequently does not accurately correct for mis-alignment of the cutting tool 35. As a result, defective prisms, (e.g., one where the bisector of the vertex is not normal to the surface, one where the misalignment angle could be as large as ±5 degrees) is generally produced during the manufacturing process.

It is therefore desirable to have a method for aligning the cutting tool so as to facilitate the manufacture of drums that permit the misalignment angle to be about 0 degrees. This minimizes the defects in the prism sheets.

### SUMMARY

Disclosed herein is a method for aligning a cutting tool comprising displacing a first slide comprising a microscope in a first direction at a first speed; displacing a second slide comprising an adjustable tool holder and a cutting tool in a second direction at a second speed; wherein the adjustable tool holder is in operative communication with the cutting tool; observing an actual path of travel of a cross hair center of the microscope with respect to a cutting edge of the cutting tool; and adjusting the position of the cutting tool so that the cutting edge of the cutting tool and the cross hair center lie in the same plane during the travel of the cross hair center.

Disclosed herein is a method for aligning a cutting tool comprising locating a cross hair center of a microscope above a first point on a cutting edge of a cutting tool; wherein the cross hair center and the first point lie in a plane; displacing a first slide comprising the microscope in a first direction at a first speed; displacing a second slide comprising an adjustable tool holder and the cutting tool in a second direction at a second speed; wherein the adjustable tool holder is in operative communication with the cutting tool; terminating the displacement of the first slide and the second slide; observing a second point on the cutting edge of the cutting tool with the cross hair center of the microscope; and adjusting the tool position to permit the second point and the cross hair center to lie in the plane.

Disclosed herein too is a method for aligning a cutting tool comprising selecting two or more points on a first cutting edge and two or more points on a second cutting edge of a cutting tool; wherein the selecting is accomplished with a cross hair center of a microscope; determining mathematical equations to the first cutting edge and the second cutting edge; mathematically determining a location of a cutting tip of the cutting tool with respect to a drum; directing travel of the cross hair center according to the mathematical equations for a desired location of the first cutting edge or the second cutting edge; and adjusting the cutting tool to permit the travel of the cross hair center to trace a path that encompasses either the first cutting edge, the second cutting edge or both the first cutting edge and the second cutting edge.

### DETAILED DESCRIPTION OF FIGURES

With reference now to the Figures, wherein like elements are numbered alike:

FIG. 1 depicts a brightness enhancing display film that comprises prisms disposed upon a film substrate;

FIG. 2 depicts a prior art method for aligning a cutting tool prior to machining a drum;

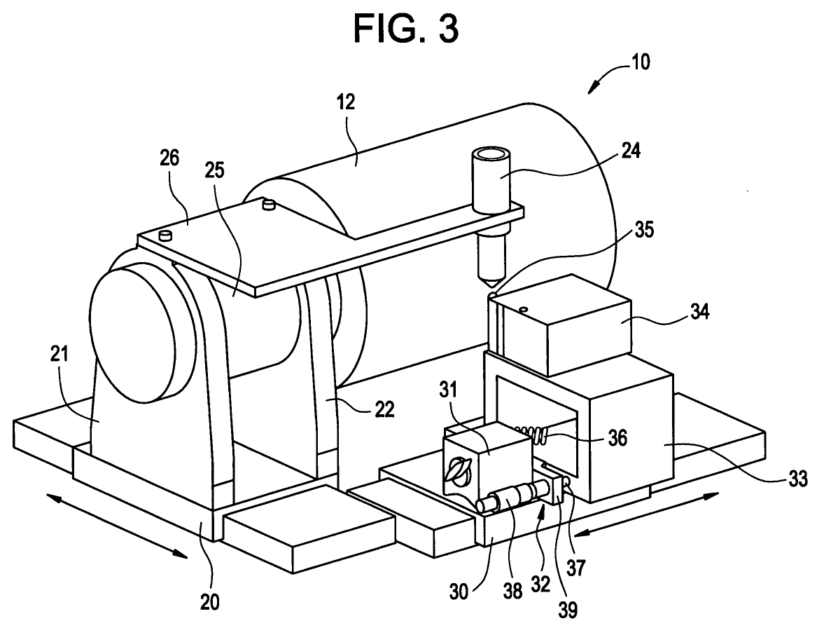

FIG. 3 displays a rear view of one exemplary embodiment of a system 10 for manufacturing the drum 12;

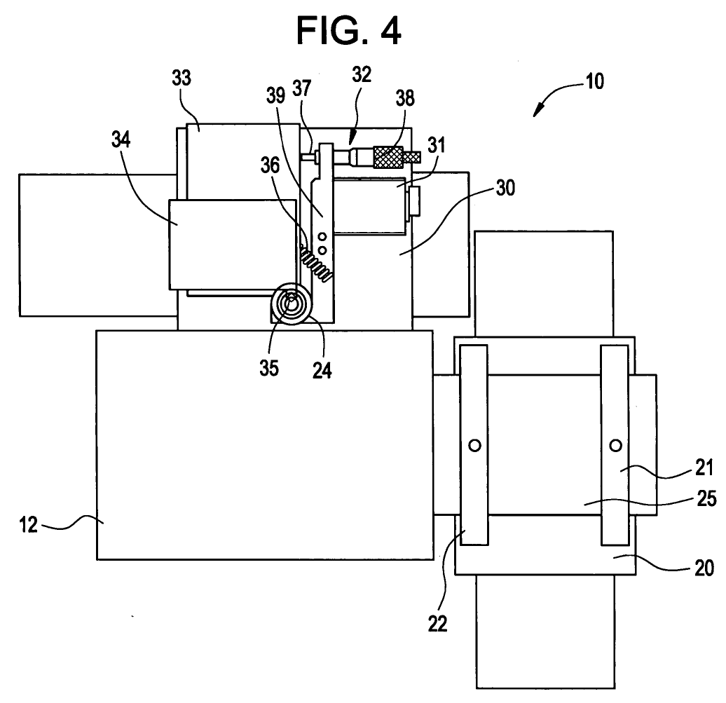

FIG. 4 displays a top view of one exemplary embodiment of a system 10 for manufacturing the drum 12;

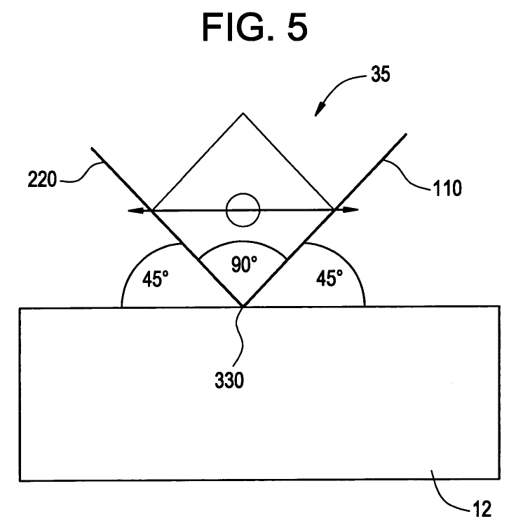

FIG. 5 depicts vertical planes inclined at 45 degrees to the surface of the drum 12 prior to machining; the vertical planes are used to align the cutting edge of the cutting tool 35;

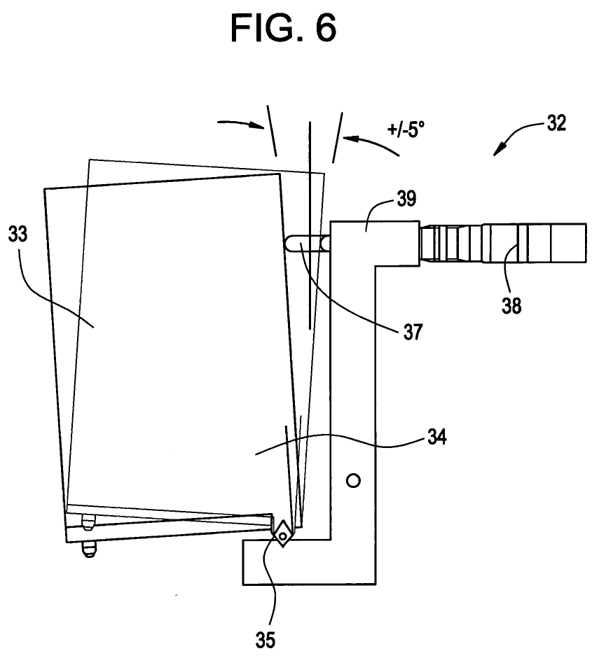

FIG. 6 depicts one exemplary embodiment of the adjustment of the cutting tool 35 by the micrometer, rotation of the micrometer screw 38 can be used to displace the cutting tool 35 by an angle of ±5 degrees.

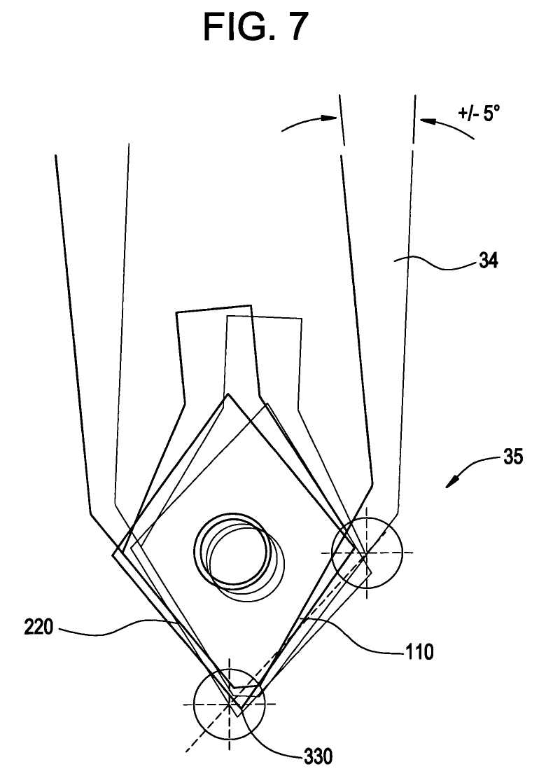

FIG. 7 depicts the cross-hairs of the microscope 24 focused on a first edge 110 of the cutting tool 35;

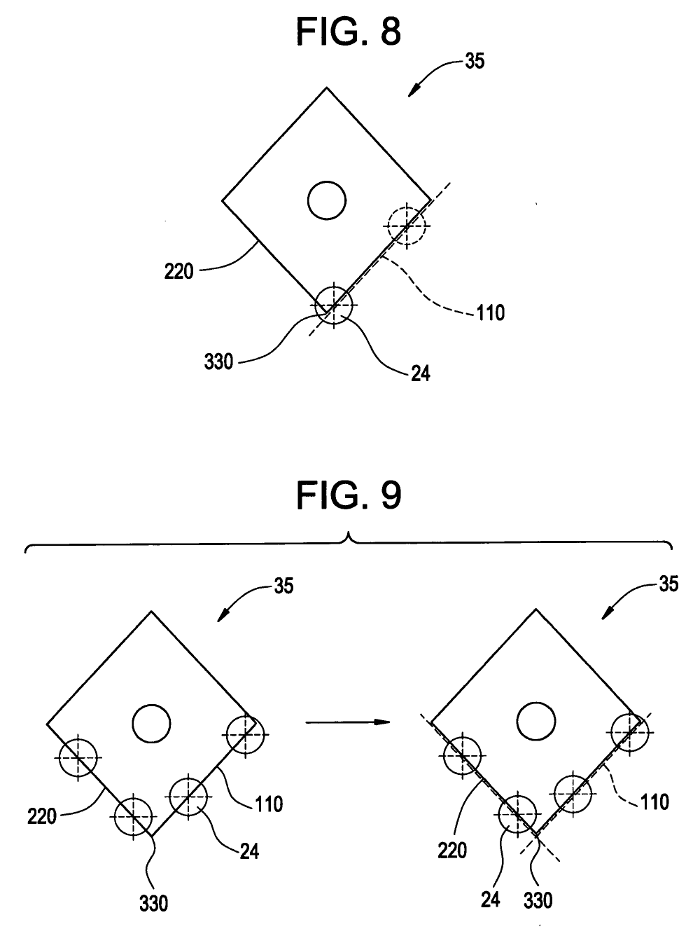

FIG. 8 depicts one exemplary manner of aligning the cutting tool by locating two points along the first cutting edge 110 of the cutting tool 35; and

FIG. 9 depicts one exemplary manner of aligning the cutting tool 35 by developing equations to the cutting edges of the tool and displacing the microscope 24 along a vertical plane that encompasses these cutting edges; FIG. 9(a) shows the choosing of two or more points on the cutting edge while in FIG. 9(b), lines are fitted through the selected points; the lines are used to determine the angles between the edges as well as the location of the cutting tip.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and independently combinable.

Disclosed herein is a method for aligning a cutting edge of a cutting tool in such a manner that the tip of the tool is aligned normal to the surface to be machined, and such that a brightness enhancement film made from such a machined surface has maximum on-axis brightness in typical LCD backlight modules. An exemplary cutting tool is a diamond-cutting tool. Aligning the cutting tool prior to a machining operation reduces the probability of manufacturing a defective cylindrical master or electroform, which reduces the probability of manufacturing a defective brightness enhancing display film.

In a first embodiment, the method comprises displacing a microscope in a first direction at a first speed while simultaneously displacing a base on which a micrometer and cutting tool are disposed in a second direction at a second speed. The cutting tool is in operative communication with an adjustable tool holder. During this relative displacement of the microscope and the cutting tool, a cutting edge of the cutting tool is observed under the microscope. If the intersection point of the cross hairs (hereinafter cross hair center) of the microscope (located in the eye piece of the microscope) remains in the same plane that encompasses the cutting edge of the cutting tool, then the cutting tool is assumed to be properly aligned. If on the other hand, the cross hair center is observed to move out of the plane that encompasses the cutting edge of the cutting tool (i.e., off the edge of the diamond tool), then a micrometer is used to modify the position of the cutting tool so that the cutting edge of the cutting tool and the cross hair center lie in the same plane during the entire path of travel of the cross hair center.

The term “encompasses” implies that the entire length of a cutting edge of the cutting tool lies in a given plane or along a given path. The plane can be a vertical plane, a horizontal plane or any plane therebetween. An exemplary plane is a vertical plane. While all future embodiments in this specification have been described as occurring in the vertical plane, it is to be noted that they can be performed in any desired plane.

In one embodiment, the cutting tool can be adjusted using the micrometer. The micrometer can be adjusted manually or using a numerically controlled device, such as, for example, a stepper motor. In another embodiment, the cutting tool can be adjusted manually without using the micrometer, i.e., the position of the adjustable tool holder can be modified manually.

In a second embodiment, the method comprises displacing the microscope along a line in a plane that is supposed to encompass the cutting edge of the cutting tool. The microscope can be stopped at any two points during its displacement or travel. If the cross hair center lies in the same plane as the cutting edge at each of these two points, then the cutting tool is presumed to be properly aligned. If however, the cross hair center is determined not to lie in the same plane as the cutting edge at each of the two points, then the position of the cutting tool is modified by using the micrometer. The modification of the position of the cutting tool is performed till the two points on the edge of the cutting tool lie in the same plane that the cross hair center travels in.

In a third embodiment, a method for aligning a cutting tool comprises selecting two or more points on a first cutting edge and two or more points on a second cutting edge of a cutting tool. If the tip of the cutting tool is used as a first point then only one other point may be selected on each edge. These points are used to determine mathematical equations to the first cutting edge and the second cutting edge. The mathematical equations are advantageously used to compute cutting tool angles and a location of the cutting tool tip. If the mathematical equations define the plane that encompasses the appropriate cutting edge, then the cutting tool is presumed to be properly aligned. If not, the micrometer is used to modify the position of the cutting tool to correct the alignment. This method may advantageously used to determine the location of the cutting tool tip when the tip is pointed or curved.

In the first embodiment, the method comprises displacing a microscope in a first direction at a first speed while simultaneously displacing a micrometer and a cutting tool in a second direction at a second speed. During this relative displacement of the microscope and the cutting tool, the cross hair center of the microscope is programmed to traverse a line that lies in a vertical plane that is inclined at 45 degrees to the surface of a drum that is to be machined. It is to be noted that the angle between the vertical plane and the surface of the drum is dependent upon the angle at the tip of the cutting tool. If the angle at the tip is 90 degrees, then the vertical plane is inclined at an angle of 45 degrees to the surface of the drum.

The edge of the cutting tool need not always be observed directly through the microscope. In one embodiment, observing the tool edge through the microscope can include forming an image of the tool edge on a video camera attached to the microscope, as opposed looking through an eyepiece.

With reference now to the FIGS. 3 and 4, which display a rear view and a top view of one exemplary embodiment of a set-up (e.g., a lathe or a turning machine) for manufacturing the drum, a system 10 for machining the drum 12 comprises a first slide 20 and a second slide 30. The first slide 20 comprises brackets 21 and 22 that are fixedly attached to a base of the first slide 20. A microscope-mounting bracket 26 is fixedly attached to the brackets 21 and 22. A microscope 24 is fixedly attached to a microscope-mounting bracket 26. The eye-piece (not shown) of the microscope 34 has cross hairs that are used for aligning the cutting tool 35. The intersection point of the cross hairs (hereinafter cross hair center) is used to align the cutting tool during the process of alignment. The brackets 21 and 22 are in a supportive relationship with the spindle 25 and provide support to the spindle while it rotates. The spindle 25 is in operative communication with a motor (not shown) that is in electrical communication with a source of power (not shown). In one embodiment, the spindle 25 is in rotary communication with the motor. A rotary couple provided by the motor is transferred to the drum 12 via the spindle 25, thereby facilitating rotation of the drum.

During the alignment process, the first slide 20 is displaced in a first direction at a first speed, while the second slide 30 is displaced in a second direction at a second speed. The first and second speeds can be the same or different. In an exemplary embodiment, the first and second speeds are selected to permit the cross hair center to travel in a plane that encompasses a cutting edge of the cutting tool. In yet another embodiment, the first and second speeds are selected to permit the cross hair center to travel in a vertical plane inclined at 45 degrees with respect to an outer surface of the drum prior to machining. As depicted in the FIG. 5, the vertical plane is inclined at 45 degrees with respect to an outer surface of the drum and encompasses the cutting edge of the cutting tool when the cutting tool is properly aligned.

In an exemplary embodiment, the first slide 20 can be displaced along an arbitrary x-axis direction, while the second slide 30 can be displaced along an arbitrary z-axis direction. The x-axis direction is mutually perpendicular to the z-axis direction. While it is generally desirable for the first slide 20 and the second slide 30 to be displaced in mutually perpendicular directions, other angles between the first slide 20 and the second slide 30 can be contemplated and used. In one embodiment, the angle between the directions of displacement of the first slide and the second slide is greater than or equal to about 75 degrees. In another embodiment, the angle between the directions of displacement of the first slide and the second slide is greater than or equal to about 55 degrees. In yet another embodiment, the angle between the directions of displacement of the first slide and the second slide is greater than or equal to about 45 degrees.

With respect now once again to the FIGS. 3 and 4, the second slide 30 has disposed upon it a magnetic tool base 31, a micrometer 32, a tool base 33, and an adjustable tool holder 34 that supports a cutting tool 35. The magnetic tool base 31 is used for attaching the micrometer 32 to the tool base 33. The tool base 33 provides support for the adjustable tool holder 34 as well as the cutting tool 35. The cutting tool 35 is in operative communication with and is held in position by the adjustable tool holder 34 that is disposed upon the tool base 33. The cutting tool has a first cutting edge 110 and a second cutting edge 220 that emanate from a cutting tip 330. An exemplary angle between the first cutting edge 110 and the second cutting edge 220 is about 90 degrees. It is further desirable for the first cutting edge 110 and the second cutting edge 220 each to be inclined at 45 degrees to the surface of the drum 12 (as depicted later in FIG. 6).

It is generally desirable for the cross hair center to travel in a vertical plane that is inclined to the surface of the drum at an angle that is generally equal to about half of the angle at the cutting tip 330 of the diamond cutting tool. For example, when the angle between the first cutting edge 110 and the second cutting edge 220 is 90 degrees (i.e., the angle at the cutting tip is 90 degrees), the displacement between the first slide 20 and the second slide 30 causes the cross hair center to travel in a vertical plane that is inclined at an angle of 45 degrees to the surface of the drum. In another example, when the angle between the first cutting edge 110 and the second cutting edge 220 is 110 degrees, the displacement between the first slide 20 and the second slide 30 causes the cross hair center to travel in a vertical plane that is inclined at an angle of 55 degrees to the surface of the drum. In yet another example, when the angle between the first cutting edge 110 and the second cutting edge 220 is 70 degrees, the displacement between the first slide 20 and the second slide 30 causes the cross hair center to travel in a vertical plane that is inclined at an angle of 35 degrees to the surface of the drum.

A jaw 37 of the micrometer 32 is in operative communication with the tool base 33 via a cantilever 39. The position of the tool base 33 and hence of the cutting tool 35 can be adjusted by rotating the micrometer screw 38. A compression spring 36 is in operative communication with the cantilever 39 and the tool base 33. The compression spring 36 reduces any play or vibration that may be generated during the machining and also facilitates maintaining the desired position of the tool base 33 until the micrometer screw 38 is rotated.

With reference now to FIG. 6, which depicts one exemplary embodiment of the adjustment of the cutting tool by the micrometer, rotation of the micrometer screw 38 can be used to displace the cutting tool by an angle of ±5 degrees. Upon rotating the micrometer screw 38, the cutting tool 35 can be displaced to bring an edge of the cutting tool 35 into a vertical plane that reduces defects in the drum. In addition, adjusting the micrometer screw 38 permits accurate and continuous adjustment of the cutting tool 35 under the microscope 24. In other words, the use of the micrometer 32 in conjunction with the microscope 34 permits very small modifications to be made to the position of the cutting tool, thus allowing for finer positioning of the cutting edge. In addition, use of the magnification provided by the microscope allows for a more precise calibration of the cutting edge position.

In one embodiment, in one exemplary manner of aligning the cutting tool 35, a target-point on an edge of the cutting tool 35 is displaced through a fixed point on the microscope 24 as shown in the FIG. 7. FIG. 7 depicts the cross-hairs of the microscope 24 focused on a first edge 110 of the cutting tool. In order to check whether the cutting tool has the desired alignment, the machine upon which the cutting tool 35 and the microscope 24 are mounted is programmed to continuously oscillate along a relative motion line as shown in the FIG. 7. During this oscillation, the first slide 20 is used to displace the cutting tool 35 in the z-direction as shown in FIG. 7, while the second slide 30 is used to displace the microscope 24 in the x-direction. The relative motion line is determined by the first speed of the first slide 20 and the second speed of the second slide 30. When the cutting tool has a cutting tip that has an included angle of 90 degrees, the first speed and the second speed are generally selected to promote motion of the cross hair center along in a vertical plane that is inclined at an angle of about 45 degrees to an outer surface of the drum.

During the oscillation along the relative motion line, it is desirable for the intersection point of the cross hairs of the microscope 24 to intersect with the first cutting edge 110 or the second cutting edge 220 of the cutting tool, throughout the travel of the microscope 32. If during the oscillation along the relative motion line, it is observed that the intersection point of the cross hairs deviates from the vertical plane encompassing the first cutting edge 110 or the second cutting edge 220 on the cutting tool, the micrometer screw 38 is appropriately rotated to promote the first cutting edge 110 or the second cutting edge 220 of the cutting tool 35 to lie in the vertical plane. Thus rotation of the micrometer screw 38 re-aligns the cutting tool 35. This procedure can be conducted along the first cutting edge 110 and the second cutting edge 220 in order to insure greater accuracy if desired.

When the cutting tool has linear cutting edges 110 and 220, it is desirable for the cross hair center to travel in a vertical plane that encompasses the cutting edge of the cutting tool 35. In other words, the cross hair center traces the cutting edge of the cutting tool. When the cross hair center traces the cutting edge of the cutting tool 35, it indicates that the cutting edge of the cutting tool 35 is appropriately aligned. It is to be noted however, that the desirability of having the cutting edge lie in a vertical plane is related to the position occupied by the cutting tool 35 in the adjustable tool holder 34. For example, if the adjustable tool holder 34 were to be rotated clockwise through an angle of 30 degrees from a vertical, then it would be desirable for the cross hair center and the vertical plane to be rotated clockwise through 30 degrees as well in order for the cross hair center to trace the cutting edge of the cutting tool 35.

When the cutting tool has curvilinear cutting edge(s) 110 and/or 220, then it is desirable for the first speed and the second speed to be selected so as to permit the cross hair center to trace the curvilinear cutting edge of the cutting tool 35. If the cross hair center does not trace the curvilinear cutting edge of the cutting tool 35, then the micrometer screw 38 is appropriately adjusted in order to realign the cutting tool 35. Realignment of the cutting tool 35 is continued until the cross hair center traces the curvilinear cutting edge of the cutting tool 35.

In another embodiment, in another manner of determining the alignment of the cutting tool 35, the cross hair center is displaced in a vertical plane that encompasses the edge of the cutting tool 35. In this embodiment, the intersection point of the cross-hairs is first positioned at a first point located on the first cutting edge 110 of the cutting tool as shown in FIG. 8. The machine then undergoes oscillation for a desired interval, whereupon a second observation is made of the intersection point of the cross-hairs and its location relative to the first cutting edge 110 of the cutting tool. If during the second observation, it is noticed that the intersection point of the cross-hairs is positioned such that it intersects with the first cutting edge 110 of the cutting tool 35 at a second point as shown in the FIG. 8, then the alignment of the cutting tool 35 is accurate. If on the other hand, it is observed that the intersection point of the cross-hairs does not intersect with the first cutting edge 110, then the micrometer screw 38 can be rotated to align the cutting tool 35.

In yet another embodiment, depicted in the FIG. 9, coordinates along the diamond edge are programmed into the machine. The coordinates are used to define a curve fitting routine (program) that can calculate the angles for the edges of the diamond as well as the location of the cutting tip 330. In one manner of practicing this embodiment, as shown in the FIG. 9, at least 4 points are located on the first cutting edge 110 and the second cutting edge 220 are identified. It is generally desirable for two or more points to be located on the first cutting edge 110 and two or more points to be located on the second cutting edge 220. These points can be used to determine mathematical equations to the straight lines that define the first cutting edge 110 and the second cutting edge 220 respectively. The intersection point of these two lines provides the cutting tip 330 location, while the slopes to the lines yield the edge angles. In one embodiment, the equations to the lines are used to define the locus of the travel (oscillation) of the machine. In another embodiment, the equations to the lines are used to define the first speed and the second speed respectively. Any deviation of the first cutting edge 110 or the second cutting edge 220 from the cross hair center indicates a mis-alignment of the cutting tool 35. As noted above, this misalignment can be corrected by rotating the micrometer screw 38.

While the embodiment depicted in the FIG. 9 exemplifies a cutting tool having linear cutting edges 110 and 220 as well as a cutting tip 330, the method can also be advantageously used on a cutting tool that has curvilinear edges as well as a curved cutting tip. By detecting a number of points along the cutting edges as well as the curved cutting tip, and using these points to generate an equation that represents the profile of the cutting tool, the first slide 20 and the second slide 30 can be displaced at rates that permits the cross hair center to travel along a locus that represents the profile of the cutting edges and the cutting tip of the cutting tool 35. In one embodiment, the cutting edges and/or the curved cutting tip can have a profile that is parabolic.

In another embodiment, an aspheric sag equation that describes the curvature of the cutting edges can be programmed into the machine. An exemplary aspheric sag equation for parabolic surfaces is described in U.S. Patent Application 2004/0109663 to Olczak, the entire contents of which are hereby incorporated by reference. The first slide 20 and the second slide 30 can be displaced at rates effective to permit the cross hair center to travel along a locus defined by the aspheric sag equation. If the cross hair center does not travel along the cutting edges of the cutting tool 35, then the position of the cutting tool 35 is adjusted as required using the micrometer.

These methods for aligning the cutting tool are advantageous in that it compensates for any misalignment between the cutting tool and the fixture 34 or any misalignment between the fixture 34 and the tool base 33. The precision offered by the rotating the micrometer screw 38 is greater than that offered by tapping the fixture into alignment as indicated in the FIG. 2. The use of the micrometer 32 in conjunction with the microscope 34 permits very small modifications to be made to the position of the cutting tool, thus allowing for finer positioning of the cutting edge. In addition, use of the magnification provided by the microscope allows for a more precise calibration of the cutting edge position. In one embodiment, the cutting tool may be aligned via a numerically controlled positioning stage (not shown).

In one embodiment, the aforementioned methods for aligning the cutting tool promotes maintaining the misalignment angle of the prisms produced from the drum to be about 0 degrees. In another embodiment, the misalignment angles of the prisms produced from the drum is up to about ±1 degrees. In yet another embodiment, the misalignment angles of the prisms produced from the drum is up to about ±2 degrees. In yet another embodiment, the misalignment angles of the prisms produced from the drum is up to about ±5 degrees. In yet another embodiment, the misalignment angles of the prisms produced from the drum is up to about ±10 degrees. An exemplary misalignment angle is less than or equal to about ±0.5 degrees.

Drums manufactured by the aforementioned methods can be advantageously used to produce replica tools that are free from inherent machining defects. An exemplary replica tool is a metal electroform. Replica tools can be used to manufacture brightness enhancing display films that have prisms whose misalignment angles are up to about ±2 degrees. It is generally desirable for the replica tool to have prisms whose misalignment angles are less than or equal to about ±0.5 degrees. Brightness enhancing display films manufactured from the replica tools can be advantageously used in display devices. Exemplary display devices are television screens or computer screens that employ liquid crystals.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method for aligning a cutting tool comprising:
displacing a first slide comprising a microscope in a first direction at a first speed;
displacing a second slide comprising an adjustable tool holder and a cutting tool in a second direction at a second speed; wherein the adjustable tool holder is in operative communication with the cutting tool;
observing an actual path of travel of a cross hair center of the microscope with respect to a cutting edge of the cutting tool; and
adjusting the position of the cutting tool so that the cutting edge of the cutting tool and the cross hair center lie in the same plane during the travel of the cross hair center.

2. The method of claim 1, wherein the first direction and the second direction are mutually perpendicular.

3. The method of claim 1, wherein the first speed and the second speed are selected to permit the cross hair center of the microscope to travel in the plane that encompasses the cutting edge of the cutting tool.

4. The method of claim 1, wherein the first speed is the same as the second speed.

5. The method of claim 2, wherein the first speed is different from the second speed.

6. The method of claim 1, wherein the plane is a vertical plane.

7. The method of claim 1, wherein the cutting tool is aligned by manually adjusting the adjustable tool holder.

8. The method of claim 1, wherein the cutting tool is aligned by using a micrometer.

9. The method of claim 1, wherein the cutting tool is aligned by using a numerically controlled positioning stage.

10. A drum manufactured by the method of claim 1.

11. A replica tool manufactured from the drum of claim 10.

12. A brightness enhancing display film manufactured from the replica tool of claim 11.

13. The brightness enhancing display film of claim 12 having a misalignment angle of up to about ±2 degrees.

14. A device that employs the brightness enhancing display film of claim 13.

15. The method of claim 1, wherein the cutting tool is a diamond-cutting tool.

16. A method for aligning a cutting tool comprising:
locating a cross hair center of a microscope above a first point on a cutting edge of a cutting tool; wherein the cross hair center and the first point lie in a plane;
displacing a first slide comprising the microscope in a first direction at a first speed;
displacing a second slide comprising an adjustable tool holder and the cutting tool in a second direction at a second speed; wherein the adjustable tool holder is in operative communication with the cutting tool;
terminating the displacement of the first slide and the second slide;
observing a second point on the cutting edge of the cutting tool with the cross hair center of the microscope; and
adjusting the tool position to permit the second point and the cross hair center to lie in the plane.

17. The method of claim 16, wherein the first direction and the second direction are mutually perpendicular.

18. The method of claim 16, wherein the plane is a vertical plane.

19. The method of claim 16, wherein the cutting tool is aligned by manually adjusting the adjustable tool holder.

20. The method of claim 16, wherein the cutting tool is aligned by using a micrometer.

21. The method of claim 16, wherein the cutting tool is aligned by using a numerically controlled positioning stage.

22. A drum manufactured by the method of claim 16.

23. A replica tool manufactured from the drum of claim 22.

24. A brightness enhancing display film manufactured from the replica tool of claim 23.

25. The brightness enhancing display film of claim 24 having a misalignment angle of up to about ±2 degrees.

26. A device that employs the brightness enhancing display film of claim 25.

27. The method of claim 16, wherein the cutting tool is a diamond-cutting tool.

28. A method for aligning a cutting tool comprising:
selecting two or more points on a first cutting edge and two or more points on a second cutting edge of a cutting tool; wherein the selecting is accomplished with a cross hair center of a microscope;
determining mathematical equations to the first cutting edge and the second cutting edge;
mathematically determining a location of a cutting tip of the cutting tool with respect to a drum;
directing travel of the cross hair center according to the mathematical equations for a desired location of the first cutting edge or the second cutting edge; and
adjusting the cutting tool to permit the travel of the cross hair center to trace a path that encompasses either the first cutting edge, the second cutting edge or both the first cutting edge and the second cutting edge.

29. The method of claim 28, wherein the first cutting edge and the second cutting edge intersect at the cutting tip, and wherein the cutting tip is selected as a point for determining the location of the first cutting edge and/or the second cutting edge.

30. The method of claim 28, wherein the cutting tool is aligned by using a numerically controlled positioning stage.

31. The method of claim 28, wherein the cutting tool is aligned by manually adjusting the adjustable tool holder.

32. The method of claim 28, wherein the cutting tool is aligned by using a micrometer.

33. The method of claim 28, wherein the first cutting edge and/or the second cutting edge is linear.

34. The method of claim 28, wherein the first cutting edge and/or the second cutting edge is parabolic.

35. A drum manufactured by the method of claim 28.

36. A replica tool manufactured from the drum of claim 35.

37. A brightness enhancing display film manufactured from the replica tool of claim 36.

38. The brightness enhancing display film of claim 37 having a misalignment angle of up to about ±2 degrees.

39. A device that employs the brightness enhancing display film of claim 38.

40. The method of claim 28, wherein the cutting tool is a diamond-cutting tool.
